(19) United States
(12) Patent Application Publication
(10) Pub. No.: US 2025/0173793 A1
(43) Pub. Date: May 29, 2025

(54) SYSTEM FOR CERTIFYING ITEMS, PARTICULARLY COLLECTIBLE ITEMS

(71) Applicants: GIOVANNI BAGGIO, San Giorgio in Bosco (IT); VTCG S.R.L., Cittadella (Padova) (IT)

(72) Inventor: Giovanni BAGGIO, San Giorgio in Bosco (IT)

(21) Appl. No.: 18/842,705

(22) PCT Filed: Jun. 15, 2022
(86) PCT No.: PCT/EP2022/066353

§ 371 Date: Aug. 29, 2024

(30) Foreign Application Priority Data
Mar. 4, 2022 (IT) 102022000004091

(51) Int. Cl. G06Q 40/06; G06F 21/60; G06Q 30/018

(52) U.S. Cl. CPC G06Q 40/06; G06F 21/602; G06Q 30/018

(57) ABSTRACT

A system for certifying an item includes an identification element of the item, which contains a unique identification code associated with the item, the identification element being of the RFID tag and/or NFC tag type, a central device having a unit for processing certification data of the item associated with the unique identification code, a memory unit which contains the certification data of the item, a module for generating a piece of certification information associated with the item, which contains the certification data and can be obtained/generated exclusively using by means of the unique identification code, and a device for reading the identification element.

### CROSS-REFERENCE TO RELATED APPLICATIONS

This application is a 35 U.S.C. § 371 National Stage patent application of PCT/EP2022/066353, filed on 15 Jun. 2022, which claims the benefit of Italian patent application 102022000004091, filed on 4 Mar. 2022, the disclosures of which are incorporated herein by reference in their entirety.

### TECHNICAL FIELD

The present disclosure relates to a system for certifying items. The disclosure can be used particularly in the field of collectible items.

### BACKGROUND

Currently, items for which an economic value, even a considerable one, is acknowledged are widespread throughout the world.

This is the case, for example, of:
items for which there is collection interest, such as playing cards, picture cards, comic books and/or items that have belonged to famous people,
works of art,
luxury items, such as bottles of wine.

Some of these items have a considerable economic value, which is determined by different factors, such as for example:
their creator,
the date of creation,
integrity and quality,
the number and/or identity of past owners,
past trading dates.

Currently, however, it is not always possible, or at any rate easy, to be able to establish and certify the value of an item and/or find information related to the above mentioned factors.

For a buyer/collector, therefore, the need arises to have a tool/certificate that helps him in determining the value of the item of his interest and that guarantees its authenticity and the correctness of the certification information related to it, which contributes to determining its economic value.

This need is even more felt because of the proliferation of fake items, in every way similar to the original ones, made ad hoc by criminals and sold to victims at the price of the original items.

### SUMMARY

The aim of the present disclosure is to provide a system for certifying items, particularly collectible items, that is capable of improving the background art in one or more of the aspects mentioned above.

Within this aim, the disclosure provides a system for certifying items, particularly collectible items, which allows the user to establish in an unequivocal and straightforward manner the authenticity of an item, its history and its grading, and therefore its economic value.

The disclosure also devises a system for certifying items, particularly collectible items, that allows an expert to grade the item easily and quickly.

The disclosure further provides a system for certifying items, particularly collectible items, that allows to provide an authenticity and/or grading and/or ownership certificate.

A further advantage of the present disclosure is to overcome the drawbacks of the background art in a manner that is alternative to any existing solutions.

Not least object of the disclosure is to provide a system for certifying items, particularly collectible items, that is highly reliable, relatively easy to provide and at competitive costs.

This aim and these and other advantages which will become better apparent hereinafter are achieved by providing a system for certifying an item, particularly a collectible item, characterized in that it comprises:
an identification element of said item, which contains a unique identification code associated with said item, said identification element being of the RFID tag and/or NFC tag type,
a central device comprising:
   a unit for processing certification data of said item associated with said unique identification code,
   a memory unit which contains said certification data of said item,
   a module for generating a piece of certification information associated with said item, which contains said certification data and can be obtained/generated exclusively by means of said unique identification code,
a device for reading said identification element, in a data connection with said central device, said reading device comprising:
   means for reading said identification element, of the RFID antenna and/or NFC antenna type,
   means for displaying said certification data of said item and/or said piece of certification information generated by said generation module,
   means for acquiring a digital image of said item,
   selection means configured to attribute a grading to said item.

### BRIEF DESCRIPTION OF THE DRAWINGS

Further characteristics and advantages of the disclosure will become better apparent from the description of a preferred but not exclusive embodiment, of the system for certifying items, particularly collectible items, according to the disclosure, illustrated by way of non-limiting example in the accompanying drawings, wherein:

FIG. 1 is a view of an embodiment of the system for certifying items, particularly collectible items, according to the disclosure; and

FIG. 2 is a view of an embodiment of a component of the system for certifying items, particularly collectible items, shown in FIG. 1.

### DETAILED DESCRIPTION OF THE DRAWINGS

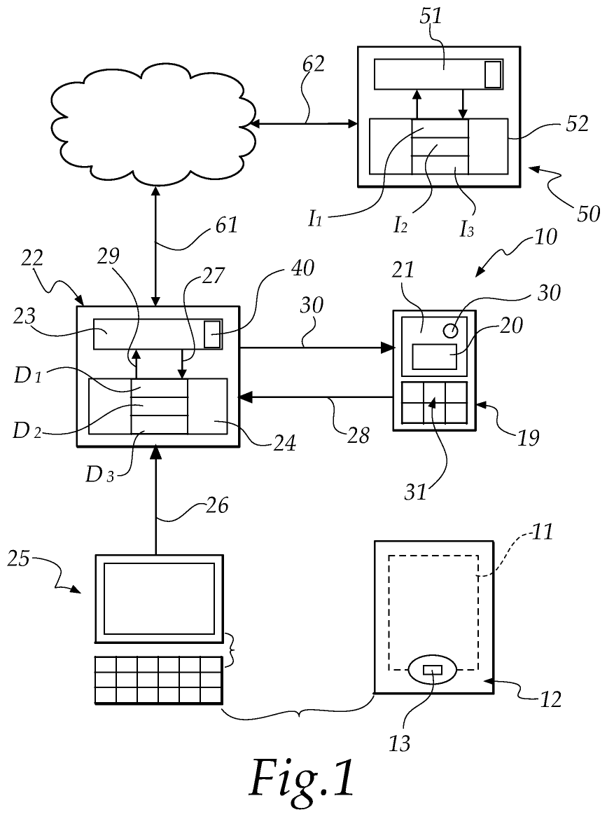

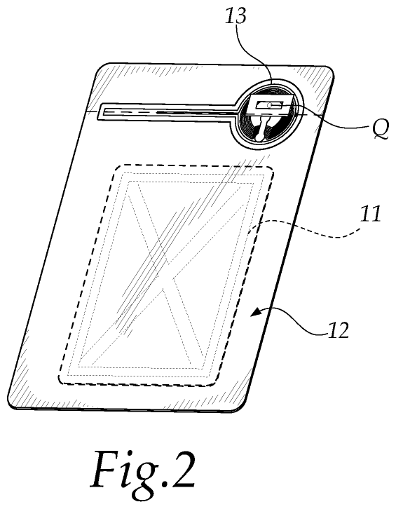

With reference to FIGS. 1 and 2, the system for certifying items, particularly collectible items, according to the disclosure is generally designated by the reference numeral 10.

The system 10 is adapted to certify one or more items 11, particularly collectible items.

In the examples shown in the figures, the item 11 is a collectible card; however, the item 11 can be any type, depending on the fields and areas of interest.

The system 10 comprises an identification element 13 of the item 11. Inside the identification element 13 there is a unique identification code Q, preferably of the alphanumeric type, associated with the item 11.

The identification element 13 is an RFID (Radio Frequency IDentification) tag and/or an NFC (Near Field Communication) tag and/or the like.

In one embodiment, the system 10 comprises one or more containers 12, each adapted to contain one or more respective items 11. In particular, the item 11 is contained and sealed inside this container 12, such as for example a pouch and/or a box.

The term “sealed”, in the present description, means that the item 11 cannot be removed from the container 12 without breaking said container.

For example, with reference to FIG. 2, to seal the item 11 inside the pouch-shaped container 12, said item 11 is inserted through the original opening inside the basic pouch, constituted by two opposite flaps made of plastic material and welded on three edges, and then this pouch is closed by heat-sealing the two flaps along the last edge.

For example, the container 12 is made of at least partially transparent plastic material and/or glass.

In another embodiment, the container 12 may comprise the identification element 13 of the item 11, or of the items 11, contained therein. The identification element 13 can be physically associated with, i.e., fixed to, the container 12. The identification element 13 is univocally correlated to the item 11, or the items 11, inside the container 12.

In another embodiment, not shown in the figures, the identification element 13 can be physically associated, i.e., fixed, directly with or to the item 11, which lacks the container 12.

For example, if the item 11 is a painting, the identification element 13 can be a label glued to the frame of said painting.

In practice, the identification element 13 can be firmly associated with the container 12 and/or the item 11.

The expression “firmly associated”, in the present description, means that the identification element 13 is applied and/or fixed with non-removable fixing means (such as adhesives) to the item 11 and/or to the container 12 and/or embedded inside the material of which the container 12 is made and it 15 is not possible to remove it from the container without breaking it irreparably.

The system 10 comprises furthermore a central device 22, such as for example a server, comprising:
a unit 23 for processing certification data D1, D2, D3, etcetera of the item 11, and
a memory unit 24 which contains said certification data D1, D2, D3, etcetera of the item 11.

The central device 22 also comprises a module 40 for generating a piece of certification information, such as for example a digital certificate, associated with the item 11, which contains the certification data D1, D2, D3 of said item 11 and can be obtained/generated exclusively by means of the unique identification code Q (key) of said item 11.

This generation module 40 produce this piece of certification information, such as for example a certificate in PDF (Portable Document Format) format, containing the certification data D1, D2, D3, etcetera, which are associated with the specific unique identification code Q, read by the reading device 19 and referred to the item 11.

For example, the module 40 for generating the piece of certification information is software dedicated to this operation.

In particular, the certification data D1, D2, D3, etcetera of the item 11 comprise at least the unique identification code Q associated with the item 11, and one or more pieces of information related to such item 11, associated with the respective unique identification code Q and selected from the group constituted by:
electronic address of the creator of the item 11,
creation date of the item 11 (creation timestamp),
electronic address of the owner of the item 11,
purchase date of the item 11 (purchase timestamp),
grading of the item 11,
grading date of the item 11 (grading timestamp), and
digital image of the item 11.

In the event of transfers of ownership of the item 11, there are multiple data items related to owner and purchase date of each trade.

The system 10 further comprises at least one reading device 19 configured to read the identification element 13 of the item 11. This reading device 19 comprises:
means 20 for reading the identification element 13, such as for example an RFID antenna and/or an NFC antenna, in order to detect/read the unique identification code Q contained in the identification element 13,
means 21 for displaying the certification data D1, D2, D3, etcetera associated with the unique identification code Q, and therefore with the item 11, and/or the piece of certification information generated by the generation module 40 mentioned above,
means 30 for acquiring a digital image of the item 11, and
selection means 31 configured to attribute a grading of the item 11.

In another embodiment, the reading device 19 is a smartphone and/or a tablet, in which:
the means 21 for displaying the certification data D1, D2, D3, etcetera are constituted by the touchscreen display of the smartphone and/or tablet,
the means 30 for acquiring a digital image of the item 11 are constituted by the camera of the smartphone and/or tablet, and
the selection means 31 configured to attribute a grading of the item 11 are constituted by one or more buttons provided on a convenient graphical interface of the touchscreen display of the smartphone and/or tablet.

In another embodiment, the reading device 19 is a computer provided with a scanner, in which:
the means 21 for displaying the certification data D1, D2, D3, etcetera are constituted by the screen of the computer,
the means 30 for acquiring a digital image of the item 11 are constituted by the scanner connected to the computer, and
the selection means 31 configured to attribute a grading of the item 11 are constituted by the keyboard and the mouse of the computer.

The selection means 31 can be used by a user/expert of the item 11 in order to give a grading, for example a numeric value from 1 to 10, where 1 is the minimum level of quality and 10 is the level of substantial perfection, to the item 11.

For example, this grading is given based on the rarity, integrity, presence/absence of flaws, etcetera, of the item 11.

If necessary, it is possible to repeat, for example at a later time, the operation of grading of the item 11, modifying, again by virtue of the selection means 31, the grading of the item 11.

In practice, the reading device 19 reads the unique identification code Q contained in the identification element 13 of the item 11 and retrieves, by means of a data connection, designated by the arrows 28 and 30, the certification data D1, D2, D3, etcetera of the item 11 that are stored in the central device 22 and associated with the unique identification code Q, which is in practice the key for access to said certification data D1, D2, D3, etcetera.

At that point the user of the reading device 19 can also modify one or more of the certification data D1, D2, D3, etcetera, but obviously not the unique identification code Q associated therewith.

The system 10 can comprise an interface 25 for entering and/or updating certification data D1, D2, D3, etcetera in the central device 22.

For example, this interface 25 for entering and/or updating the certification data D1, D2, D3, etcetera is a computer and/or a tablet and/or a dedicated computing device.

This interface 25 for entering and/or updating the certification data D1, D2, D3, etcetera can correspond to the reading device 19.

The interface 25 for entering and/or updating the certification data DI, D2, D3, etcetera can be:
connected directly to the central device 22 by means of a physical connection, for example an electrical connection, or
connected remotely to the central device 22, for example by means of a telematics communication network or a Wi-Fi and/or Bluetooth connection.

A computer program for the management of these certification data D1, D2, D3, etcetera is installed and/or can be installed in the central device 22, particularly in the corresponding unit 23 for processing the certification data D1, D2, D3, etcetera.

The central device 22, particularly the corresponding unit 23 for processing the certification data D1, D2, D3, etcetera is configured to:
receive the certification data D1, D2, D3, etcetera entered and/or updated by means of the interface 25 (arrow 26) or by means of the reading device 19 (arrow 28),
store the certification data D1, D2, D3, etcetera in the memory unit 24 (arrow 27),
receive requests of certification data D1, D2, D3, etcetera from the reading device 19 (arrow 28), after the reading means 20 have decoded the identification element 13 and read the unique identification code Q,
obtain the certification data D1, D2, D3, etcetera, required by the reading element 19 in the memory unit 24 (arrow 29),
provide the certification data D1, D2, D3, etcetera to the reading device 19 (arrow 30).

The reading device 19 can be:
connected directly to the central device 22 by means of a physical connection, for example an electrical connection, or
connected remotely to the central device 22 by means of a telematics communication network or a Wi-Fi and/or Bluetooth connection.

In one embodiment, within the scope of the system 10 according to the disclosure, each real item 11 corresponds to a respective digital twin. In this embodiment, the central device 22 is connected by means of a telematics communication network to at least one remote device 50, such as for example a server, which operates as a node of a distributed ledger infrastructure of a blockchain in which an NFT (Non Fungible Token) associated with said digital twin of the real item 11 is registered.

In practice, it is possible, after generating a digital twin of the real item 11, not shown in the figures, to associate therewith an NFT that in practice certifies and ensures its ownership and authenticity and which can be accessed only by virtue of the unique identification code Q associated with the real item 11, this unique identification code Q being read by the reading device 19.

In particular, the remote device 50 comprises:
a unit 51 for processing certification data 11, 12, 13, etcetera of the digital twin of the real item 11,
a memory unit 52 which contains said certification data 11, 12, 13, etcetera of the digital twin of the real item 11.

In particular, the certification data 11, 12, 13, etcetera of the digital twin of the real item 11 are included in the NFT associated with such digital twin of the real item 11 and comprise at least the unique identification code Q associated with the real item 11, and one or more pieces of information related to the digital twin of the real item 11, associated with the respective unique identification code Q and selected from the group constituted by:
electronic address of the creator of the digital twin of the real item 11,
creation date of the digital twin of the real item 11 (creation timestamp),
electronic address of the owner of the digital twin of the real item 11,
purchase date of the digital twin of the real item 11 (purchase timestamp),
grading of the digital twin of the real item 11,
grading date of the digital twin of the real item 11 (grading timestamp),
hash code of the digital twin of the real item 11.

In the event of transfers of ownership of the digital twin of the real item 11, which can also correspond to the total or partial transfer of ownership of the real item 11, there are multiple data related to the owner and the purchase date of each trade.

Advantageously, each certification data item 11, 12, 13, etcetera of the digital twin of the real item 11 is equal to the respective certification data item D1, D2, D3, etcetera, of said real item 11, if present. In other words, the electronic address of the creator of the digital twin of the real item 11 is equal to the electronic address of the creator of said real item 11, and so forth.

The module 40 for generating a piece of certification information, which as mentioned is comprised in the central device 22, can also provide, as a piece of certification information, the NFT associated with the digital twin of the real item 11, and optionally other information associated therewith, based on the unique identification code Q of the real item 11, read by the reading device 19, by means of a data communication between the central device 22 and the remote device 50 (arrows 61, 62).

In practice, by reading the unique identification code Q contained in the identification element 13 of the real item 11, the system 10 is capable of providing the user with a piece of certification information comprising data related to the real item 11, such as for example the creator and the date of creation, owner, grading, etcetera, and a piece of certification information in form of an NFT comprising data related to the digital twin of the real item 11, such as for example the creator and the date of creation, owner, grading, etcetera.

In practice it has been found that the disclosure achieves the intended aim and objects, providing a system for certifying items that allows the user to establish in an unequivocal and straightforward manner the authenticity of an item and its grading.

The disclosure provides a system for certifying items that allows an expert to grade the item easily and quickly.

Moreover, the disclosure provides a system for certifying items that allows to provide an authenticity and/or grading and/or ownership certificate.

The disclosure thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

1-8. (canceled)

9. A system for certifying an item comprising:
an identification element of said item, which contains a unique identification code associated with said item, said identification element being of an RFID tag and/or NFC tag type,
a central device comprising:
a unit for processing certification data of said item associated with said unique identification code,
a memory unit which contains said certification data (of said item,
a module for generating a piece of certification information associated with said item, which contains said certification data and can be obtained/generated exclusively using said unique identification code,
a device for reading said identification element, in a data connection with said central device, said reading device comprising:
reading means configured for reading said identification element, of the RFID antenna and/or NFC antenna type,
display means configured for displaying said certification data of said item and/or said piece of certification information generated by said generation module,
acquisition means configured for acquiring a digital image of said item, and
selection means configured to attribute a grading of said item.

10. The system for certifying an item according to claim 9, wherein said certification data of said item comprise at least said unique identification code associated with said item, and one or more pieces of information related to said item and selected from the group constituted by:
electronic address of the creator of said item,
creation date of said item,
electronic address of the owner of said item,
purchase date of said item,
grading of said item,
grading date of said item, and
digital image of said item.

11. The system for certifying an item according to claim 9, further comprising an interface for entering and/or updating said certification data of said item in said central device, said interface being in a data connection with said central device.

12. The system for certifying an item according to claim 9, wherein said module for generating a piece of certification information is configured to produce a piece of certification information containing said certification data associated with said unique identification code read by said reading device and referred to said item.

13. The system for certifying an item according to claim 9, wherein said central device is connected by a telematics communication network to at least one remote device which operates as a node of a distributed ledger infrastructure of a blockchain in which an NFT associated with a digital twin of said item is registered.

14. The system for certifying an item according to claim 9, wherein said remote device comprises:
unit for processing certification data associated with said digital twin of said item, and
a memory unit which contains said certification data of said digital twin of said item.

15. The system for certifying an item according to claim 14, wherein said certification data of said digital twin of said item are included in said NFT associated with said digital twin of said item and comprise at least said unique identification code associated with said item and one or more pieces of information related to said digital twin of said item which are selected from the group constituted by:
electronic address of the creator of said digital twin of said item,
creation date of said digital twin of said item,
electronic address of the owner of said digital twin of said item,
purchase date of said digital twin of said item,
grading of said digital twin of said item,
grading date of said digital twin of said item, and
hash code of said digital twin of said item.

16. The system for certifying an item according to claim 13, wherein said module for generating a piece of certification information is configured to provide, as certification information, said NFT associated with said digital twin of said item, on the basis of said unique identification code associated with said item and read by said reading device.
